(19) United States
(12) Patent Application Publication
(10) Pub. No.: US 2005/0034587 A1
(43) Pub. Date: Feb. 17, 2005

(54) Cutting blade that can be rotationally driven

(76) Inventors: Gunther Weber, Zachow (DE); Matthias Kraft, Alt Kablich (DE)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/495,006

(22) PCT Filed: Nov. 11, 2002
(86) PCT No.: PCT/EP02/12590

(30) Foreign Application Priority Data
Nov. 9, 2001 (DE) 10155048.0

(51) Int. Cl. B26D 1/00; B26D 7/06

(52) U.S. Cl. 83/703; 83/651; 83/932; 83/663

(57) ABSTRACT

The invention relates to a cutting blade that can be rotationally driven in which a stabilization area provided in the form of at least one bulge is provided between a central fixing area and an edge area whose outer periphery is provided in the form of a cutting edge.

The invention relates to a rotatingly drivable cutting blade, in particular for apparatuses working with a high cutting sequence for the slicing of food products such as ham, sausage, cheese and the like, comprising a central securing zone and an outer periphery serving as a cutting edge.

Very high demands with respect to stiffness and strength are made on such blades which are in particular used with so-called slicers for the slicing of food products. These demands have the consequence that these blades have to be made in expensive manufacturing processes and have a relatively high weight.

It is the object of the invention to provide a blade of the initially recited type which is characterized by higher stiffness with simultaneously lower weight with respect to conventional blades and which can moreover be manufactured in a cost-favorable manner.

This object is satisfied in accordance with the invention substantially in that a stabilizing zone in the form of at least one circularly extending arch is provided between the substantially planar central securing zone, which has at least one central opening, and a marginal zone whose outer periphery is made as a cutting edge.

The circularly extending arch, which is in particular designed in bead shape, results in a high stiffness of the blade with a comparatively low material strength and in no way impairs the marginal blade design, in particular the form of the cutting edge.

Particularly advantageous embodiments of the invention are recited in the dependent claims.

An embodiment of the invention is explained with reference to the drawing whose single FIGURE shows a schematic axial sectional view of an embodiment of a blade in accordance with the invention.

The blade designed for use in slicers includes a central, substantially planar securing zone 1 having a central opening 2. This opening 2 serves for securing purposes in the case of a circular blade and for centering in the case of a scythe-like blade, with a plurality of securing openings arranged distributed around the opening 2 with a radial spacing from the opening 2 being provided with such a scythe-like blade.

This central securing zone 1 merges radially outwardly into an arch 7 which forms a stabilizing zone. The arch 5, which is continuously curved in cross-section, surrounds the central securing zone 1 such that it lies in a depression in a practically recessed manner.

A marginal zone 3 radially outwardly adjoins the arch 5 and its periphery is made as a cutting edge 4. If, on the one hand, a base plane 6 is laid through the cutting edge 4 and a top plane 7 is laid through the apex of the arch 5, the central securing zone 1 is located between these two planes 6, 7, with the arch 5 and the inclination of the marginal zone 3 being selected with respect to the mentioned planes, which are parallel to one another such that, as a rule, the spacing of the central securing plane 1 is smaller with respect to the base plane 6 than with respect to the top plane 7.

The principle in accordance with the invention of the increase of the strength and stiffness of the blade with a simultaneous minimizing of the weight can be used both with blades whose cutting edge lies on a circle and with blades whose cutting edge extends in the manner of a scythe or over the periphery with an increasing radius.

With a ring-shaped arch 5 closed on itself, the scythe-like extent of the cutting edge can be achieved by a corresponding design of the marginal zone 3, but it is also possible to have the arch 5 follow the extent of the cutting edge over the periphery such that the marginal zone 3 also has a substantially similar radial extent over its periphery with a scythe-like blade.

### Reference Numeral List

1 central securing zone

2 central opening

3 marginal zone

4 cutting edge

5 arch (stabilizing zone)

6 base plane

7 top plane

8 transition region

9 blade axis

1. A rotatingly drivable cutting blade, in particular for apparatuses working with a high cutting sequence for the slicing of food products such as ham, sausage, cheese and the like,
comprising a central securing zone (1) and an external periphery serving as a cutting edge,
characterized in that
a stabilizing zone in the form of at least one circularly extending arch (5) is provided between the substantially planar central securing zone (1), which has at least one central opening (2), and a marginal zone (3) whose outer periphery is made as a cutting edge (4).

2. A cutting blade in accordance with claim 1, characterized in that the arch (5) is made in bead shape.

3. A cutting blade in accordance with claim 1 or claim 2, characterized in that the plane of the central securing zone (1), considered in the axial direction, is disposed between a base plane (6) extending through the cutting edge (4) and a top plane (7) extending through the apex of the arch (5).

4. A cutting blade in accordance with claim 3, characterized in that the spacing of the central securing zone (1) from the base plane (6) is smaller than its spacing from the top plane (7).

5. A cutting blade in accordance with any one of the preceding claims, characterized in that the marginal zone (3) extends toward the base plane (6) at an acute angle.

6. A cutting blade in accordance with any one of the preceding claims, characterized in that the radial extent of the arch (5) approximately corresponds to the radial extent of the marginal zone (3).

7. A cutting blade in accordance with any one of the preceding claims, characterized in that the outer periphery of the marginal zone (3) provided with the cutting edge (4) is circular.

8. A cutting blade in accordance with one or more of claims 1 to 6, characterized in that the arch (5) at least substantially follows the extent of the cutting edge in the peripheral direction of the blade with a cutting edge (4) extending in scythe-like shape.

9. A cutting blade in accordance with one or more of claims 1 to 6, characterized in that the arch (5) extends concentrically to the blade axis (9) with the cutting edge (4) extending in scythe-like shape.

10. A cutting blade in accordance with claim 8 or claim 9, characterized in that the central opening (2) forms a centering aperture; and in that securing openings are provided with a radial spacing from said centering aperture and are distributed around it.
